(19) United States
(12) Patent Application Publication
(10) Pub. No.: US 2017/0282388 A1
(43) Pub. Date: Oct. 5, 2017

(54) RAZOR CARTRIDGE WITH FLUID MANAGEMENT SYSTEM

(71) Applicant: The Gillette Company LLC, Boston, MA (US)

(72) Inventors: Roderick Andrew Haines, Cambridge (GB); James Simon Oliver, Cambridge (GB); Mark Peterson, Reading (GB); Joia Kirin Spooner-Fleming, Jamaica Plain, MA (US); Alison Fiona Stephens, Maidenhead (GB); James Tandy, Singapore (SG); Paul Leslie Warrick, Woodcote (GB); Finbarr Charles Ronald Williamson, London (GB)

(21) Appl. No.: 15/464,730

(22) Filed: Mar. 21, 2017

(30) Foreign Application Priority Data
Mar. 31, 2016 (EP) 16163187.4
Mar. 14, 2017 (EP) 17160791.4

(51) Int. Cl. B26B 21/44

(52) U.S. Cl. CPC B26B 21/446

(57) ABSTRACT

A razor cartridge comprising a housing having an elongated skin contacting element having a plurality of tunnels extending there through to facilitate fluid flow to the blades.

### FIELD OF THE INVENTION

The invention relates to the management of fluid in hair removal devices such as razor cartridges and foils during shaving.

### BACKGROUND OF THE INVENTION

Razor cartridges are typically provided with a guard in front of the blades and a cap behind the blades which contact the skin before and after the blades respectively. The guard and cap may aid to establish the “shaving geometry” i.e. the parameters which determine blade orientation and position relative to the skin and have a strong influence on shaving performance and efficiency of the razor.

The guard is present on the razor cartridge to manage the skin and stretch the skin prior to contact with the blade to ensure optimal contact with the blade without negative skin sensations. The guards are typically provided from an elastomeric or thermoplastic material to further improve skin contact and tactile performance. Recently guards having longitudinal fins formed from such elastomeric materials have been incorporated on the cartridge in order to improve the orientation of the hair in order to maximize cutting efficiency.

In order to provide lubrication to the skin during the shave, a shaving preparation is typically applied to the skin prior to shaving. This may be provided as separately dispensed shaving preparation from a container or may be contained within the handle of the razor and dispensed through channel passages as described for example in U.S. Pat No. 2,131,498 and U.S. Pat. No. 4,077,199. In addition, the razor cartridge may also be provided with a shaving aid usually present on the cap and/or guard. The shaving aid contains a lubricant typically within a matrix structure, which is designed to release lubricant with water gradually during each shaving occasion and deposit onto the skin. The lubricant is beneficial in reducing the friction between the skin and the blades.

However it has been found that the optimization of the guard performance for skin stretch may impact the performance of the lubricating material from the shaving aid or preparation in that the guard reduces the ability of the lubricating material to contact the skin at the contacting points of the blade and skin.

There is thus a need to provide a razor cartridge which has a guard to provide the desired skin stretch and orientation prior to contact with the blade while ensuring sufficient contact of the fluid, shaving aid or lubricant with the skin to ensure a close and comfortable shaving experience without irritation.

### SUMMARY OF THE INVENTION

A razor cartridge comprising a housing (20) having a proximal end portion (24), a distal end portion (26), and first lateral end portion (28) and second lateral end portion (30), and at least one blade (22) positioned between said proximal (24) and distal (26) end portions; said housing (20) comprising an elongated skin contacting element (60) located in front of said blade (22), wherein said elongated resilient skin contacting element (60) has a proximal end portion (72) and a distal end portion (70) and at least one fluid tunnel (62) extending from said proximal end portion (72) to said distal end portion (70) within said elongated skin contacting element.

### BRIEF DESCRIPTION OF THE DRAWINGS

FIG. 1 is a top view of one possible embodiment of a shaving razor of the present invention.

FIG. 2 is a detailed top plan view of an alternative embodiment of a cartridge of the present invention.

FIG. 3 is a partial top plan view of an elongated skin contacting element of the cartridge of FIG. 2.

FIG. 4A is an enlarged partial top plan view of the cartridge of FIG. 2.

FIG. 4B is a partial cross section view of the cartridge, taken generally along the line 4-4 of FIG. 2.

FIG. 4C is a partial cross section view of the cartridge along line 4-4 of FIG. 2 having a lubricating member.

FIG. 5 are cross sectional views of alternative configurations of the tunnels (62).

FIG. 6 is a partial top view cut away of an alternative embodiment of the cartridge shown in FIG. 1.

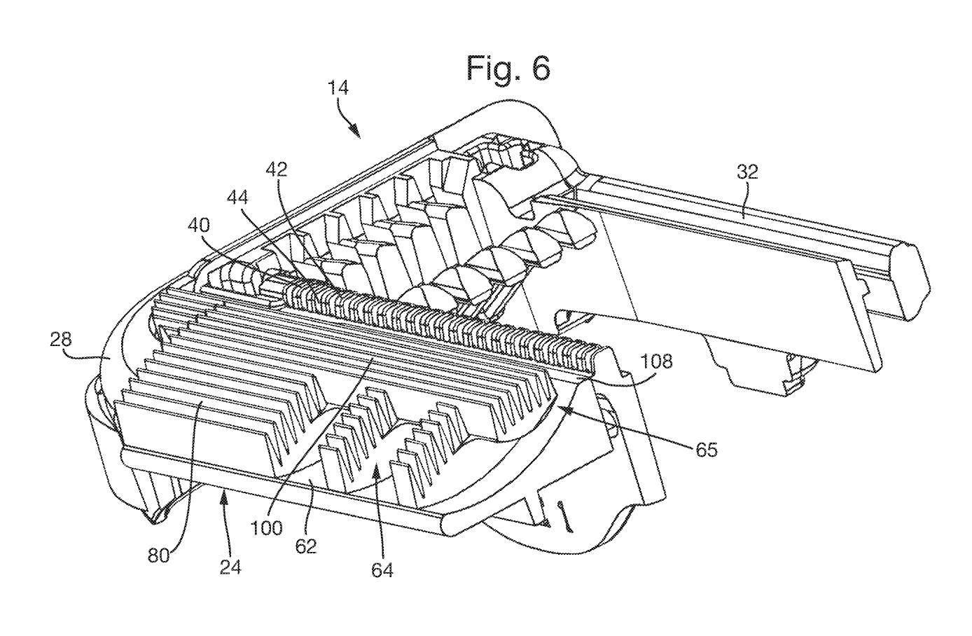

### DETAILED DESCRIPTION OF THE INVENTION

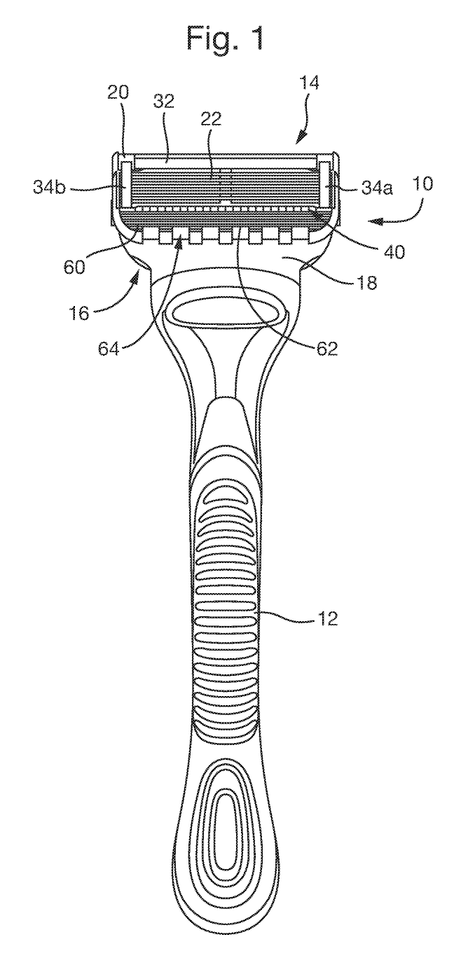

Referring to FIG. 1, one possible embodiment of the present invention is shown illustrating a shaving razor (10) having a handle (12) and a cartridge (14). In certain embodiments, the cartridge (14) may be detached and removed from the handle (12). The cartridge (14) may be fixedly or pivotably mounted to the handle (12). The cartridge (14) may also include an interconnect member (16) to which the cartridge (14) is pivotably mounted about a pivot axis. The interconnect member (16) may include a base (18) which is connected to the handle (12). The cartridge (14) may include a housing (20) that carries one or more blades (22), preferably at least two or at least three or at least five blades, a cap (32), and an elongated skin contacting element (60). The one or more blades (22) may be mounted within the housing (20) and secured with a pair of clips (34a and 34b). Other assembly methods known to those skilled in the art may also be used to secure the blades (22) to the housing (20) including, but not limited to, wire wrapping, cold forming, hot staking, insert molding, and adhesives. The housing (20) may include a skin contacting bar (40) positioned adjacent the elongated skin contacting element (60). The skin contacting bar (40), as illustrated in FIG. 1, has a generally rectangular cross section, but any number of cross sectional shapes are possible, such as a circle, square, triangle, or oval. As will be described in greater detail below, the elongated skin contacting element (60) may have one or several discrete arrays of skin contacting members (80, 90 and 100) to facilitate localized stretching of skin and/or orientation of hair. The elongated skin contacting element (60) may be used in combination with or independently of the skin contacting bar (40). As will also be described in greater detail below the elongated skin contacting element (60) further comprises at least one tunnel (62) which is provided with a tunnel inlet (64) and tunnel outlet (65).

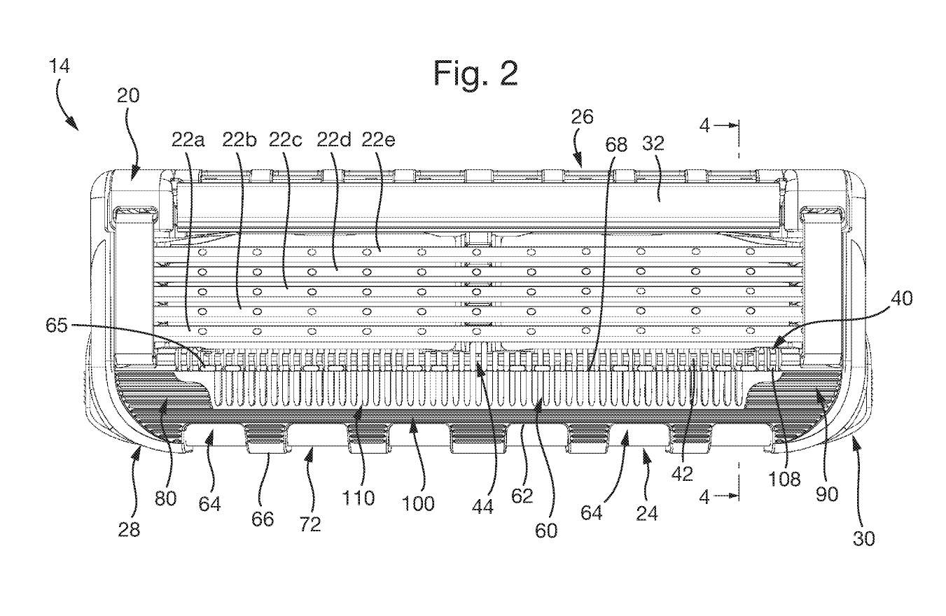

Referring to FIG. 2, a top plan view of an alternative cartridge embodiment (14) is shown. The housing (20) may have a proximal end portion (24), a distal end portion (26), a first lateral end portion (28), and a second lateral end portion (30). The cap (32) may be disposed at the distal end portion (26) of the housing (20) and may include a lubricating strip which is secured to the housing (20). The skin contacting bar (40) may be disposed at the proximal end portion (24) of the housing (20) directly adjacent to the first blade (22a) and the elongated skin contacting element (60). In one embodiment the skin contacting bar (40) may be separated from the elongated contacting element (60) by an elongated gap (108) and described in more detail hereinafter. The blades (22a-22e) may each have a respective blade edge that cuts the hair passing from skin contacting bar (40). The edge of the first blade (22a) may be spaced apart from the skin contacting bar (40) by distance of about 0.40 mm, 0.50 mm, or 0.60 mm to about 0.75 mm, 1.25 mm, or 1.5 mm. The design of the skin contacting bar (40) may allow for a larger or smaller distance between the skin contacting bar (40) and the edge of the first blade (22a). In certain embodiments, the spacing between the skin contacting bar (40) and the edge of the first blade (22a) may be less than about 0.05 mm and the skin contacting bar (40) may even touch the edge of the first blade (22a) for improved safety.

The skin contacting bar (40) may extend longitudinally from the first lateral end portion (28) to the second lateral end portion (30) of the housing (20). A plurality of generally rigid projections (42) may extend along the skin contacting bar (40) generally perpendicular to the first blade (22a). The generally rigid projections (42) may be integral with or secured separately to the skin contacting bar (40). The generally rigid projections (42) may be spaced apart to define an open channel (44). The generally rigid projections (42) may be disposed along a substantial length of the skin contacting bar (40). Alternatively, the generally rigid projections (42) may extend along only certain sections of the skin contacting bar (40), such as in a middle portion or at the lateral end portions (28 and 30). The relatively large number of generally rigid projections (42) over the length of the skin contacting bar (40) may better distribute forces applied by the skin contacting bar (40) to the skin surface, especially if the skin contacting bar (40) is made from a generally rigid material. In certain embodiments, the skin contacting bar (40) may have about 20, 30, or 40 to about 60, 70, or 80 generally rigid projections (42), depending on the pitch and length of the skin contacting bar (40). In one embodiment the skin contacting bar may have from about 45 to about 65 generally rigid projections, or from about 50 to about 60 generally rigid projections and consequently the skin contacting bar (40) may have about 21, 31, or 41 to about 61, 71, or 81 corresponding channels (44) between. In one embodiment the skin contacting bar has 55 channels and 54 rigid projections. The greater number of generally rigid projections (42) may also allow more hairs to pass between adjacent generally rigid projections (42), which may increase the number of hairs that are properly oriented prior to reaching the first blade (22a). The generally rigid projections (42) may have a pitch of about 0.20 mm, 0.40 mm, or 0.60 mm to about 0.8 mm, 1.0 mm, or 1.2 mm.

The skin contacting bar (40) may be integral with the housing (20) or may be secured to the housing (20) using mechanical, thermal or chemical manufacturing processes. The skin contacting bar (40) may be injection molded from a semi-rigid polymer material. A stiff or rigid material may allow the housing (20) to maintain a consistent geometry during shaving and enhance the ability of the generally rigid projections (42) to lift and orient hairs. The skin contacting bar (40) may be of sufficient stiffness such that the generally rigid projections (42) do not bend or flex under normal shaving conditions, which may adversely influence shave geometry. In certain embodiments, the skin contacting bar (40) may be molded from the same material as the housing (20), for example, Noryl™ (a blend of polyphenylene oxide (PPO) and polystyrene developed by General Electric Plastics, now SABIC Innovative Plastics). The skin contacting bar (40) may be molded from other semi-rigid polymers preferably having a Shore A hardness of about 50, 60, or 70 to about 90, 110, or 120. In alternative embodiments, a segmented dynamic flexing cartridge may be provided having one or more skin contacting bars (40) each having one or more generally rigid projections (42).

The elongated skin contacting element (60) may be disposed at the proximal end portion (24) of the housing (20) directly adjacent the skin contacting bar (40) if present The elongated skin contacting element (60) may extend longitudinally from the first lateral end portion (28) to the second lateral end portion (30) of the housing (20). The skin contacting bar (40) and the elongated skin contacting element (60) may be contacting or spaced apart. In one embodiment the skin contacting bar (40) is separated from the elongated resilient contacting element (60) by an elongated gap (108).

The elongated skin contacting element (60) may comprise a plurality of distinct arrays of skin contacting members, which may include one or more lateral arrays of skin contacting members (80 and 90), and an elongated array of skin contacting members (100). The arrays of skin contacting members (80, 90, and 100) can have different sizes, shapes, and geometries. In particular, the arrays of skin contacting members (80, 90 and, 100) can be in the form of nubs or fin segments that are spaced apart or interconnected. The arrays of skin contacting members (80, 90 and 100) may also have different patterns or may be oriented at different angles with respect to the blades, e.g., in zigzag, chevron, herringbone, parallel or checkerboard patterns. The arrays of skin contacting members (80, 90, and 100) can also take the form of spaced fin segments that are arranged in rows oriented generally parallel to the blades or spaced fin segments that are arranged both parallel to and perpendicular to the blades.

In certain embodiments, the elongated skin contacting element (60) may be insert injection molded or co-injection molded to the housing (20), however, other known assembly methods may also be used such as adhesives, ultrasonic welding, or mechanical fasteners. The elongated skin contacting element (60) and the array of skin contacting members (80, 90, and 100) may be molded from a softer material than the skin contacting bar (40). For example, the elongated skin contacting element (60) and the array of skin contacting members (80, 90 and 100) may have a Shore A hardness of about 20, 30, or 40 to about 50, 60, or 70. In one embodiment the elongated skin contacting element (60) is resilient. The elongated skin contacting element (60) and the array of skin contacting members (80, 90 and 100) may be made from thermoplastic elastomers (TPEs) or rubbers; examples may include, but are not limited to silicones, natural rubber, butyl rubber, nitrile rubber, styrene butadiene rubber, styrene butadiene styrene (SBS) TPEs, styrene ethylene butadiene styrene (SEBS) TPEs (e.g., Kraton), polyester TPEs (e.g., Hytrel), polyamide TPEs (Pebax), polyurethane TPEs, polyolefin based TPEs, and blends of any of these TPEs (e.g., polyester/SEBS blend). In certain embodiments, the elongated skin contacting element 60 and the array of skin contacting members (80, 90 and 100), may comprise Kraiburg HTC 1028/96, HTC 8802/37, HTC 8802/34, or HTC 8802/11 (KRAIBURG TPE GmbH & Co. KG of Waldkraiburg, Germany). A softer material may enhance skin stretching, as well as provide a more pleasant tactile feel against the skin of the user during shaving. A softer material may also aid in masking the less pleasant feel of the harder material of the housing (20) and/or the skin contacting bar (40) against the skin of the user during shaving.

The elongated skin contacting element (60) may comprise any structure or coating to increase the friction in order to effectively engage with and stretch the skin. In one embodiment the elongated skin contacting element (60) may comprise a plurality of three dimensional microstructures. The three dimensional shapes can comprise polyhedrons, hemispheres, cones, cubes, cylinders and combinations thereof. The structures may be close packed or oriented at a distance from one another. The structures can be formed from a base substrate alone or a base structure with a coating wherein the coating partially or totally covers the base substrate. The base substrate can comprise materials selected from the materials listed hereinabove and materials such as polyurethane, aluminium, polypropylene, steel, glass acrylic, polyimide, polyetheretherketone, biopolymer or combinations thereof. In certain embodiments the base structure may comprise materials to enable the high friction microstructures to wear away and signal end of cartridge life. The coating may act to modulate the friction or aesthetic appearance of the base substrate or act as a barrier between the skin and the base substrate or a combination thereof. The base structure and coating may be joined to the housing using a number of conventionally known attachment mechanisms including, but not limited to, adhesive, injection molding, ultrasonic bonding, bonding, insert molding, over molding or combinations thereof.

In one embodiment the elongated skin contacting element (60) may be coated with a material to modulate friction. In wet shaving hydrophobic or omniphobic surfaces would generally be chosen to provide this benefit. Any suitable route for creating this coating can be considered including chemical bonding (ionic or covalent), physi sorption of suitable moieties. Examples of such techniques would be hydrophobic polymer brushes via ATRP reaction chemistry or liquid infused porous surface e.g. SLIPS. Preferably the coating technique is chosen to be able to withstand the aggressive conditions that the skin contacting surface experiences.

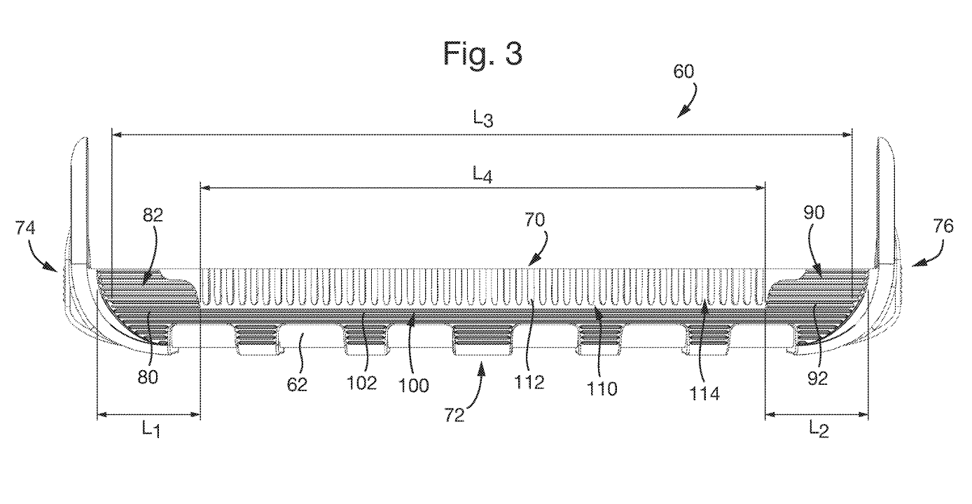

Referring to FIG. 3, a top plan view of the elongated skin contacting element (60) of FIG. 2 is shown. The elongated skin contacting element (60) may include a distal end portion (70), a proximal end portion (72), a first lateral end portion (74) and a second lateral end portion (76). The elongated skin contacting element (60) may include one or more lateral arrays of skin contacting members (80 and 90). One of the lateral arrays of skin contacting members (80) may be disposed at the first lateral end portion (74) and another lateral array of skin contacting members (90) may be disposed at the second lateral end portion (76) of the elongated skin contacting element (60). The lateral arrays of skin contacting members (80 and 90) may have a similar pattern, such as one or more flexible skin-engaging projections (82 and 92) that extend generally parallel to the blades. One lateral array of skin contacting members (80) may have a length L₁ that extends from the first lateral end portion (74) towards the second lateral end portion (76). In certain embodiments, L₁ may be about 0.5 mm, 1 mm, or 3 mm to about 5 mm, 7 mm, or 9 mm. The other lateral array of skin contacting members (90) may have a length L₂ that extends from the second lateral end portion 76 towards the first lateral end portion 74. In certain embodiments, L₁ and L₂ may be generally the same, for example, L₂ may be about 0.5 mm, 1 mm, or 3 mm to about 5 mm, 7 mm, or 9 mm. The lengths L₁ and L₂ may provide for increased skin stretching at the first and second lateral end portions (74) and (76) relative to an area between the first and second lateral end portions (74 and 76). A force applied by the elongated resilient skin contacting element 60 to the surface of the skin may not be uniform along its entire length. Additional skin stretching may be needed at the lateral end portions (74 and 76) of the elongated skin contacting element (60) to provide for a more uniform skin stretching profile along the length of the elongated skin contacting element (60). A more uniform skin stretching profile may result in a more consistently close and comfortable shave along the entire length of the cartridge (14), rather than a close and comfortable shave along only certain areas of the cartridge (14).

The elongated array of skin contacting members (100) may be disposed at the proximal end portion (72) of the elongated resilient skin contacting element (60) and or may extend from the first lateral end portion (74) to the second lateral end portion (76). The elongated array of skin contacting members (100) may be continuous with one or more of the lateral arrays of skin contacting members (80 and 90) and may have a similar pattern, such as one or more flexible skin-engaging projections (102) that extend generally parallel to each other and/or to the blades. Alternatively, the elongated array of skin contacting members (100) may be discontinuous with the lateral arrays of skin contacting members (80 and 90) and may have a dissimilar pattern. The elongated array of skin contacting members (100) may be positioned generally on the same plane as the lateral arrays of skin contacting members (80 and 90) to provide for more uniform skin stretching. For example, if a plane of the elongated array of skin contacting members (100) was positioned below a plane of the lateral arrays of skin contacting members (80 and 90), the elongated array of skin contacting members (100) may not provide tactile sensation during shaving or apply sufficient force to stretch the skin. Insufficient skin stretching between the first and second lateral ends (74 and 76) may result in increased nicks and a less smooth shave. The elongated array of skin contacting members (100) may have a length L₃ that extends from the first lateral end portion (74) to the second lateral end portion (76). In certain embodiments, L₃ may be greater than L₁ or L₂, for example, L₃ may be about 20 mm, 25 mm, or 30 mm to about 35 mm, 45 mm, or 55 mm.

The alignment array of skin contacting members (110) may be disposed at the distal end portion (70) of the elongated resilient skin contacting element (60) directly adjacent to the elongated array of skin contacting members (100) and between the lateral arrays of skin contacting members (80 and 90). The alignment array of skin contacting members (110) may have a length L₄ that extends between the first lateral end portion (74) and the second lateral end portion (76). In certain embodiments, L₄ may be greater than L₁ or L₂, for example, L₄ may be about 10 mm, 15 mm, or 20 mm to about 30 mm, 40 mm, or 50 mm. The alignment array of skin contacting members (110) may have a different pattern than the lateral arrays of skin contacting members (80 and 90) or the elongated array of skin contacting members (100). For example, the alignment array of skin contacting members (110) may include a plurality of flexible skin-engaging projections (112) that are generally transverse to the blades and define a plurality of open channels (114) that facilitate passage and orientation of hair from the elongated array of skin contacting members (100) to one or more of the blades during shaving. The flexible skin-engaging projections (112) may be disposed generally along a substantial length of the elongated resilient skin contacting element (60). For example, the alignment array of skin contacting members (110) may be disposed along about 65%, 75% or 85% to about 90%, 95% or 100% of the overall length of the elongated resilient skin contacting element (60). Although the alignment array of skin contacting members (110) is shown disposed along a substantial length of the elongated resilient skin contacting element (60), other configurations are also possible depending on the desired level and location of skin stretching and hair orientation.

The number of flexible skin-engaging projections (112) along the length of the elongated resilient skin contacting element (60) may vary. For example, the alignment array of skin contacting members (110) may have a total of about 30, 40, or 50 to about 60, 80, or 100 flexible skin-engaging projections (112), but more or less are possible depending on the pitch and length L₄ of the alignment array of skin contacting members (110). The flexible skin-engaging projections (112) may have the same pitch as the generally rigid projections (42), as previously described. In certain embodiments, the flexible skin-engaging projections (112) may have a pitch of about 0.20 mm, 0.40 mm, or 0.60 mm to about 0.8 mm, 1.0 mm, or 1.2 mm. A larger number of flexible skin-engaging projections (112) may increase the total contact area with the surface of the skin, which may increase the amount of skin stretching, as well as increase the pleasant tactile feel to the user. The flexible skin-engaging projections (112) may also facilitate proper orientation of hairs in front of the blades.

In certain embodiments, flexible skin-engaging projections (112) may not stretch the skin as much as the flexible skin-engaging projections (82 and 92). The primary function of the alignment array of skin contacting members (110) may be to direct hairs and prevent the hairs from bending over, thus the alignment array of skin contacting members (110) does not provide optimal skin stretching, as do the lateral arrays of contacting members (80 and 90). The elongated array of skin contacting members (100) may provide for additional needed skin stretching toward the center of the elongated resilient skin contacting element (60), which may compensate to provide for a more uniform stretching of skin along a length of the elongated resilient skin contacting element (60).

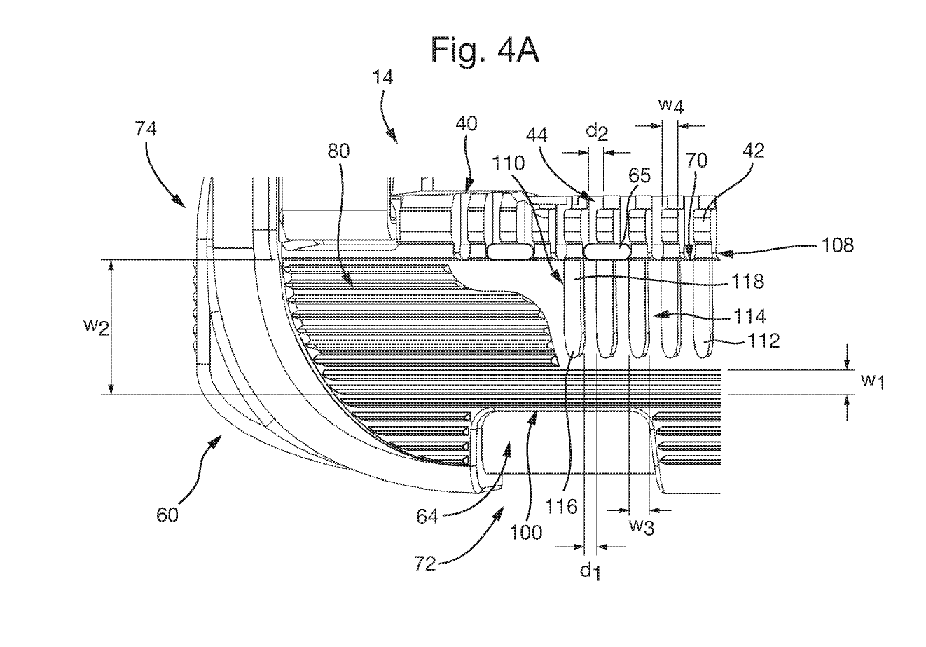

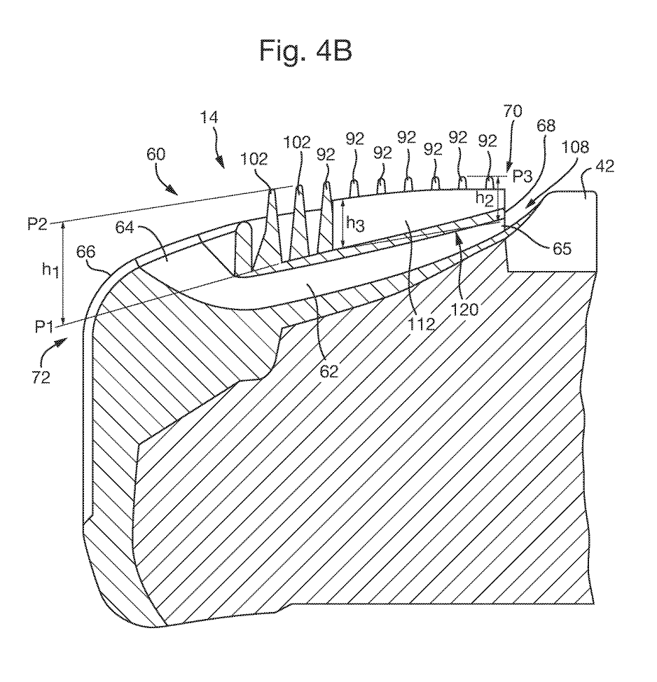

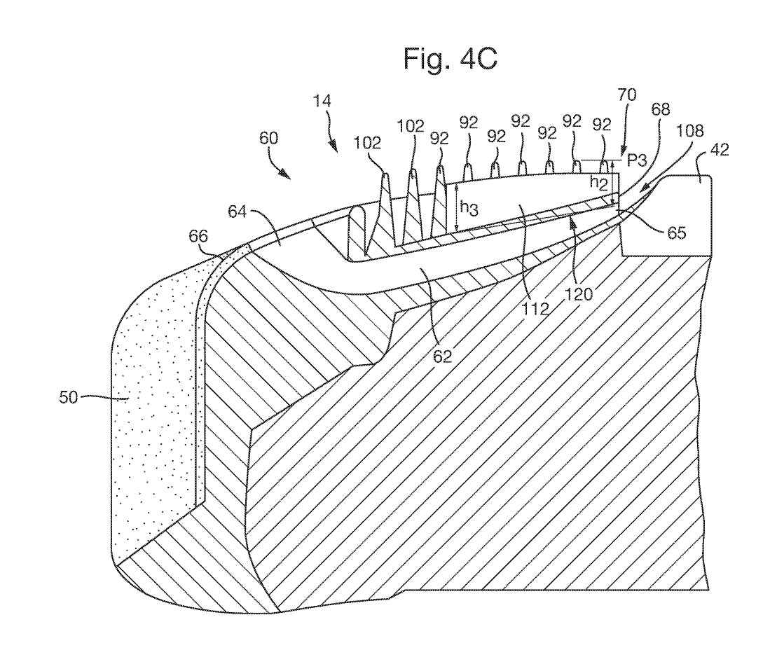

Referring to FIG. 4A, an enlarged partial top plan view of the cartridge (14) of FIG. 2 is shown. Typically guards only have a single pattern that is either traverse to the direction of shaving (which is not optimal for skin stretching) or is parallel to the shaving direction (which is not optimal for hair alignment and may remove too much shave preparation). The elongated skin contacting element 60 may have several distinct arrays of skin contacting members ((80, 90 (not shown) and 100)) which can be used in combination with the skin contact bar (40) to provide an optimum balance of skin stretching and proper hair alignment. In certain embodiments, the elongated array of skin contacting members (100) may have a different length, width, orientation, or pattern compared to the lateral array of skin contacting members (80 and 90 not shown) to provide varying levels of localized skin stretching while decreasing the number of hairs that remained pressed against the skin just prior to the blades.

The flexible skin-engaging projections (112) may have a generally rectangular or oblong geometry with a leading portion (116) and a trailing portion (118). The leading portion (116) may be tapered, rounded or have a chamfer to funnel the hair toward the blades and minimize the number of hairs that may become trapped under the flexible skin engaging projections (112). The channels (114) and the orientation of the flexible skin-engaging projections (112) may maintain a sufficient amount of shave preparation on the surface of the skin and the hair. A sufficient amount of preparation is needed to enhance hydration of the hair and decrease friction when the hair is cut by the blade(s). The channels (114) are open to allow the flow through of shave preparation instead of functioning as a squeegee which may remove too much shave preparation as discussed hereinafter.

Additional skin stretching may be provided by the lateral arrays of skin contacting members 80 and 90 (not shown) and the skin contacting bar (40). The lateral arrays of skin contacting members (80 and 90 (not shown)) may have a width “w₂” that is greater than w₁ of the elongated array of skin contacting members (100) to provide for additional localized skin stretching at the lateral ends 74 and 76 (not shown) of the elongated skin contacting element (60), which may result in a more uniform skin stretching profile of the elongated skin contacting element (60). For example, w₂ of the lateral arrays of skin contacting members (80 and 90 (not shown)) may be about 0.5 mm, 1.5 mm, or 2 mm to about 2.5 mm, 3 mm, or 3.5 mm.

The elongated gap (108) may extend generally the length of the skin contacting bar (40), but may be shorter if desired. The elongated gap (108) may be provided to facilitate the release of any hair that might be pressed against the surface of the skin back to a more upright orientation as the hair passes to the skin contacting bar (40). The elongated gap (108) may have a width of about, 0.1 mm or 0.2 mm to about 0.3 mm, 0.4 mm, or 0.5 mm. In certain embodiments, the elongated gap (108) may extend continuously along the length skin contacting bar (40) or the elongated gap (108) may include segments that extend in a discontinuous manner along the length of the skin contacting bar (40). The elongated gap (108) may have a depth of at least 0.1 mm, or 1.0 mm.

The flexible skin-engaging projections (112) may be aligned with the generally rigid projections (42), such that, a generally unobstructed passage for hair is provided with minimal tugging or pulling of hair. The generally rigid projections (42) of the skin contacting bar (40) may facilitate the management of skin and the guiding of hair to the first blade. The generally rigid projections (42) may also facilitate the lifting of hairs from the surface of the skin. Adjacent generally rigid projections (42) may be spaced apart to define the open channel (44) that is dimensioned to facilitate the generally unobstructed passage of hair to the first blade with minimal pulling or tugging of the hair, which may result in discomfort. The open channels (44) may also be dimensioned to reduce skin bulges and pressure points at ends of the generally rigid projections (42), which may result if the spacing is too great between adjacent generally rigid projections (42). For example, if the generally rigid projections (42) are spaced too far apart, skin may bulge into the open channel (44) which may result in the skin being unnecessarily sliced or cut by one or more of the blades. In certain embodiments, the generally rigid projections (42) may be spaced apart (i.e., the open channel 44) by a dimension “d₂” of about 0.10 mm, 0.20 mm or 0.30 mm to about 0.35 mm, 0.40 mm, or 0.49 mm, however d₂ may be larger or smaller depending on the thickness and amount of hair passing through the open channels (44). Improper spacing may result in discomfort caused by pressure points, skin bulges and/or the pulling of hair.

The generally rigid projections (42) may be sufficiently rigid such that the geometry of the open channels (44) remains consistent during shaving, thus maintaining optimum blade-skin geometry resulting in a closer and more comfortable shave. A top face of the skin contacting bar (40) may be generally flat for improved management of skin flow and increased comfort. In certain embodiments, the generally rigid projections (42) may have a width “w₄” that is generally equivalent to d₂. For example, the w₄ may be about 0.10 mm, 0.20 mm, or 0.30 mm to about 0.35 mm, 0.40 mm, or 0.49 mm, however w₄ may also be larger or smaller depending on the desired total contact area with the skin surface. The open channels (44) defined by the generally rigid projections (42) may be generally aligned with the open channels (114) defined by the flexible skin-engaging projections (112) such that hair is allowed to pass generally unobstructed from the elongated resilient skin contacting element (60) to the first blade. In certain embodiments, d₁ and w₃ may be generally the same as d₂ and w₄ (respectively) to facilitate the unobstructed passage of hair to the blades. The dimensions of generally rigid projections (42), the open channels (44), the flexible skin-engaging projections (112), and the open channels (114) may allow for an optimal balance of skin management, comfort, hair orientation, and rinsability.

Referring to FIG. 4B the flexible skin-engaging projections 82 (not shown), 92 and 102, and 112 may extend from a base (120) of the elongated resilient skin contacting element (60). The base (120) may be inclined along a generally curved plane P1. A top surface of the flexible skin-engaging projections (102) may be oriented along a generally inclined curved plane P2. The flexible skin-engaging projections (102) may have a height h₁, as measured from P1 to P2, of about 0.25 mm, 0.50 mm, or 0.75 mm to about 1.0 mm, 1.25 mm, or 2 mm. A top surface of the flexible skin-engaging projections (82 and 92) may be oriented along a generally inclined curved plane P3. The flexible skin-engaging projections (82 and 92) may have a height h₂, as measured from P1 to P3, of about 0.1 mm, 0.25 mm, or 0.5 mm to about 0.75 mm, 1.0 mm, or 1.5 mm. In certain embodiments, h₁ may be greater than h₂, to provide the flexible skin-engaging projections (102) with increased flexibility and skin stretching properties. It is understood that due to the possible inclines of planes P1, P2 and P3, the height (h1, h2 and h3) of the individual flexible skin-engaging projections 82 (not shown) and 92 and 102 may vary along the elongated resilient skin contacting element (60).

The elongated skin contacting element (60) comprises at least one, preferably a plurality of tunnels (62) which extend from the first proximal end portion (72) through the elongated resilient skin contacting member 60 to the first distal end portion (70) of the elongated skin contacting member (60). The elongated skin contacting element (60) may have from about 1 tunnel to 12 tunnels or from about 2 to 9 tunnels or from about 3 to 7 tunnels.

It has been found that the provision of at least one tunnel to provide an enclosed fluid pathway through the elongated skin contacting element enables the desired fluid to be delivered to the blade array (22) without necessitating modification of the skin contacting surface of the elongated skin contacting element (60) and thereby reducing the efficacy of the skin stretch functionality thereof. In a preferred embodiment of the present invention the combination of elongated skin contacting element (60), having tunnels therein and an optional lateral array or skin contacting members, together with the skin contact bar (40) and elongated gap (108) facilitate the continuous flow of lubricant to the blades while ensuring the desired skin stretch and hair management and orientation before the blades to ensure a close and comfortable shaving experience without irritation.

Each tunnel inlet for fluid entry (64) is typically located in the first proximal end portion (72) of the elongated resilient skin contacting member (60). Similarly, each tunnel outlet (65) for fluid exit is located in the first distal end portion (70). Each tunnel inlet may independently have a substantially tapered edge. Each tunnel inlet for fluid entry (64) and tunnel outlet (65) form a fluid pathway to enable the flow of liquid through the elongated skin contacting member (60) and to exit therefrom.

In one embodiment, the tunnel inlets may be located on the front peripheral edge (66) of the first proximal end portion (72) of the elongated resilient skin contacting element (60). In another embodiment the tunnel outlets (65) may be located on the rear peripheral edge (68) of the first distal end portion (70). The tunnel inlets (64) and tunnel outlets (65) may independently have a chamfered edge. The front and rear peripheral edges (66 & 68) of the elongated skin contacting element (60) may be substantially perpendicular to the blade (22) plane or may be at an angle thereto. In one embodiment, at least one of the tunnel inlets (64), alternatively all of the tunnel inlets (64) are in alignment with the front edge of the elongated skin contacting element (60). The tunnel inlets (64) and tunnel outlets (65) are preferably located such that fluid can flow freely into the tunnels without any obstruction. Preferably the fluid inlets (64) of said channels (62) are coincident with the edge of the proximal end portion (24) edge of said housing (20).

In one embodiment the channels (114) may be orientated and substantially aligned with the tunnel inlets (64).

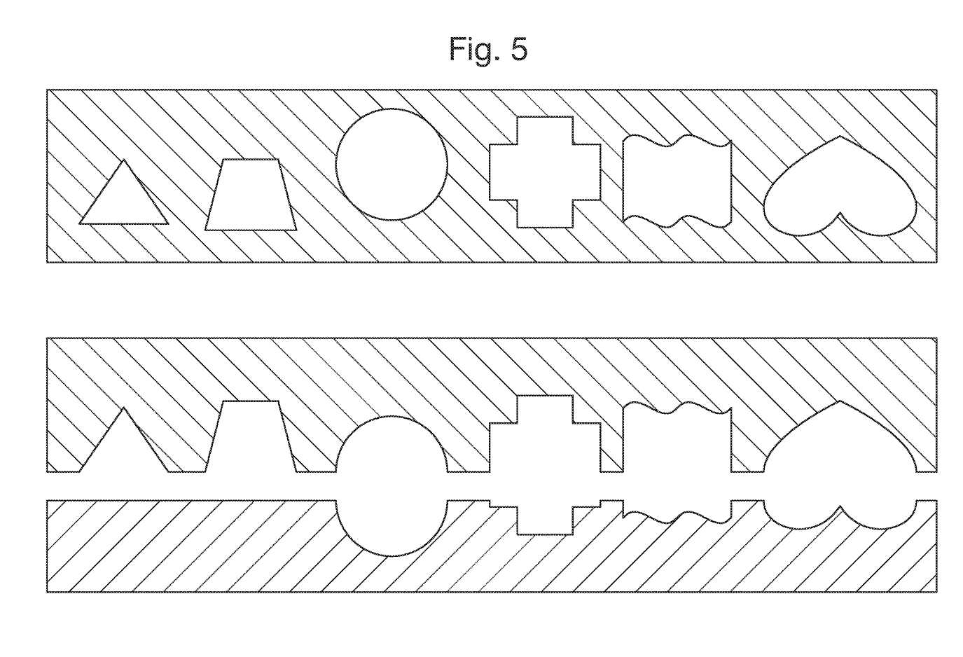

The tunnels (62) may have any shape or size, but are typically substantially cylindrical, tubular, or truncated cone or truncated pyramid in shape and may be identical, similar, or different in size and shape as shown in the cross sections of FIG. 5. Preferably, the tunnels (62) do not have any angular corners or edges to facilitate fluid flow, particularly of viscous compositions through the tunnels (62).

Each tunnel may independently have a tunnel diameter or major axis of from about 0.3 mm to about 5.0 mm or from about 1.0 mm to about 2.5 mm. In one embodiment the tunnel diameter or major axis is substantially uniform along the entire length of the tunnel. In another embodiment the tunnel diameter or major axis at the tunnel inlet (64) may be greater or less than the tunnel outlet (65). In one embodiment the tunnel inlet (64) diameter or major axis is greater than the diameter or major axis of the corresponding tunnel outlet (65), preferably at a ratio of from 10:1, or more preferably from 5:1. The diameter or major axis of the tunnel outlet (65) may be from 0.3 mm to about 20.0 mm or from about 1.0 mm to 4.0 mm. In one embodiment the channel inlet (64) diameter or major axis is greater than the diameter or major axis of the corresponding channel outlet (65), preferably at a ratio of from 10:1, or more preferably from 5:1. The diameter or major axis of the channel outlet (65) may be from 0.2 mm to about 2.0 mm or from about 0.4 mm to 0.9 mm. In one embodiment, the tunnel may be tapered or graduated through a portion of its length. For example the tunnel inlet (64) and or outlet (65) may each independently have a funnel or funnel like shape.

The tunnels have a length that substantially corresponds to the length of the elongated skin contacting element (60) and is typically from about 2.0 mm to about 8.0 mm, preferably from about 3.0 mm mm to about 6.0 mm from the first proximal end (72) to the first distal end (70). However in other embodiments, at least one or more of the tunnels may extend beyond the elongated skin contacting element (60). The tunnel outlet (64) may be adjacent to or also extend into the elongated gap (108) if present in order to ensure that the fluid accumulates therein prior to passing through the blade array.

Each tunnel may independently have a volume of from about 2.0 mm³ to 8.0 mm³, or from about 3.0 mm³ to about 6.0 mm³.

The tunnels may each independently provide a straight, curved, or angular fluid pathway from the fluid inlet (64) to the fluid outlet (65). The tunnel pathway may be substantially perpendicular to the blade array. The fluid pathway may be located to be substantially parallel to the skin contacting surface of the elongated skin contacting member (60). In another embodiment the fluid pathway of the tunnels may independently extend towards the skin contacting surface of the elongated skin contacting member.

The tunnels (62) may be formed as a single structure for example within a single elongated resilient contacting member (60) or may be formed from separate components which are assembled to form the tunnels and optionally the elongated skin contacting element (60). In one embodiment at least a portion of the tunnel(s) may be formed from a secondary component. In another embodiment at least a portion of the tunnel(s) may be formed by the insertion of a secondary structure into the elongated resilient skin contacting element (60). In another embodiment the tunnels may be formed from the combination of the elongated skin contacting element (60) and the housing (20) or a portion of the housing (20).

In another embodiment an elongated strengthening means may be located adjacent or within and integral with the elongated skin contacting means (60). The elongated strengthening means may extend from the first lateral end portion (28) to the second lateral end portion (29) or a portion thereof and/or from the first lateral portion end portion (74) to the second lateral end portion (76).

The elongated strengthening means may assist in ensuring that the tunnel cross section form is maintained upon the application of pressure against the skin of the elongate skin contacting element (60) to enable the continuous flow of fluid through the tunnels (62). The elongated strengthening means may be formed from the same material as the housing (20) and or the elongated skin contacting element (60). In one embodiment the elongated strengthening means has a Shore A Hardness of between 30 and 120.

In another embodiment, the absence of the above discussed elongated strengthening means (may result in the tunnels (62) becoming deformed during cartridge use as the elongated skin contacting element (60) is pressed against the user's skin. Such deformation may enable the tunnels to function as a pump to thereby pump the fluid through the tunnels (60) as the pressure against the skin is increased and decreased as the cross sectional diameter or major axis decreases.

In certain embodiments, the tunnels (62) may be molded from the same material as the housing (20) and/or the elongated resilient skin contacting element (60), for example, Noryl™ (a blend of polyphenylene oxide (PPO) and polystyrene developed by General Electric Plastics, now SABIC Innovative Plastics). The tunnels may be molded from other semi-rigid polymers preferably having a Shore A hardness of from about 30, 40, 50, 60, or 70 to about 90, 110, or 120. The tunnels alternatively may be made from thermoplastic elastomers (TPEs) or rubbers; examples may include, but are not limited to silicones, natural rubber, butyl rubber, nitrile rubber, styrene butadiene rubber, styrene butadiene styrene (SBS) TPEs, styrene ethylene butadiene styrene (SEBS) TPEs (e.g., Kraton), polyester TPEs (e.g., Hytrel), polyamide TPEs (Pebax), polyurethane TPEs, polyolefin based TPEs, and blends of any of these TPEs (e.g., polyester/SEBS blend), or may comprise Kraiburg HTC 1028/96, HTC 8802/37, HTC 8802/34, or HTC 8802/11 (KRAIBURG TPE GmbH & Co. KG of Waldkraiburg, Germany).

The tunnels may be formed using known manufacturing techniques such as injection molding, ultrasonic welding, and the like.

Shaving Aid

The razor cartridge may further comprise a lubricating strip or shaving aid comprising a lubricant, or lubricating material. The lubricating material can be in various forms, as well as mixtures/combinations thereof, as will be described below. The lubricating strip may be located in front or behind of the blades (22) and may be statically or spring mounted on the housing (20). For embodiments where the shaving aid is located in front of the blades in particular in front of the elongated skin contacting element (60), the shaving aid is also provided with tunnels or channels and corresponding openings thereof, which preferably correspond with the tunnels of the elongated skin contacting element (60). Alternatively the lubricating member (50) can be located below the tunnel inlets as shown in FIG. 4C.

A lubricating member can be comprised of any solid chemistry on a razor cartridge and is often referred to as a shaving aid. The shaving aid on a razor cartridge is often in the form of a strip and is referred to as a lubrastrip. Lubrastrips are typically in the form of a water insoluble structurant or matrix polymer such as ethylene-vinyl acetate (EVA) or high impact polystyrene (HIPS) and a water soluble lubricant such as a high molecular weight polyethylene oxide. Other forms of shaving aid include but are not limited to soaps and other lubricating chemistries which can be produced by hot molding, injection molding, extrusion or other processes known in the art.

In the case of a matrix of high molecular weight polyethylene oxide and high impact polystyrene the high impact polystyrene serves as the supporting structure for the lubricating strip and the high molecular weight polyethylene oxide serves as the lubricating component. Examples of suitable lubricating members are described in U.S. Pat. No. 7,811,553; U.S. 2008/0060201A1; U.S. 2009/0223057A1 and GB 2138438B.

The razor cartridges of the present invention may also find particular utility for liquid dispensing razors wherein the handle of the razor comprises a cavity for containing a composition. The composition is typically dispensed using an actuator from the cavity to a fluid dispensing member having at least one dispensing orifice and optionally a one way valve.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising a housing having a proximal end portion, a distal end portion and first and second lateral end portions, and at least one blade positioned between said proximal and distal end portions; said housing comprising an elongated skin contacting element located in front of said blade, wherein said elongated skin contacting element has a proximal end portion and a distal end portion and at least one fluid tunnel extending from said proximal end portion to said distal end portion within said elongated skin contacting element.

2. A razor cartridge according to claim 1, wherein said elongated skin contacting element comprises at least 2 of said tunnels.

3. A razor cartridge according to claim 1, wherein said elongated skin contacting element comprises from 1 to 12 of said tunnels.

4. A razor cartridge according to claim 1 wherein each of said tunnels independently has a diameter or major axis of from 0.3 mm to 5.0 mm.

5. A razor cartridge according to claim 1, wherein said elongated skin contacting element is resilient.

6. A razor cartridge according to claim 5, wherein said elongated skin contacting element comprises a plurality of distinct arrays of skin contacting members.

7. A razor cartridge according to claim 1, wherein said housing comprises a skin contacting bar adjacent said elongated skin contacting element.

8. A razor cartridge according to claim 7, wherein said skin contacting bar is separated from said elongated contacting element, by an elongated gap.

9. A razor cartridge according to claim 1, wherein said housing further comprises at least one shaving aid.

10. A razor cartridge according to claim 2, wherein each of said tunnels has a tunnel inlet and a tunnel outlet.

11. A razor cartridge according to claim 2, wherein each of said tunnel inlets is located on the peripheral edge of said elongated skin contacting element.

12. A razor cartridge according to claim 2, wherein each of said tunnels are independently tubular or truncated tubular in shape.

13. A razor cartridge according to claim 10, wherein each tunnel inlet diameter is greater than the diameter or major axis of the corresponding tunnel outlet, preferably at a ratio of from 10:1.

14. A razor cartridge according to claim 2, wherein each of said tunnels have a length of from 2.0 mm to 8.0 mm.

15. A razor cartridge according to claim 2, wherein each of said tunnels has a volume of 3.0 mm³ to 6.0 mm³.

16. A razor cartridge according to claim 7, wherein said gap has a width of 0.2 mm to 0.5 mm and preferably extends the length of the skin contacting bar.

17. A razor cartridge according to claim 2, wherein said tunnel inlets and/or said tunnel outlets have a tapered edge.

18. A razor cartridge according to claim 1, wherein said fluid inlets of said tunnels are coincident with the edge of the proximal end portion edge of said housing.
